(19) United States
(12) Patent Application Publication
(10) Pub. No.: US 2018/0216564 A1
(43) Pub. Date: Aug. 2, 2018

(54) VALVE TIMING CONTROL DEVICE

(71) Applicant: DENSO CORPORATION, Kariya-city, Aichi-pref. (JP)

(72) Inventor: Yutaka HAYAKAWA, Kariya-city (JP)

(21) Appl. No.: 15/745,494

(22) PCT Filed: Jul. 22, 2016
(86) PCT No.: PCT/JP2016/071493

§ 371 Date: Jan. 17, 2018

(30) Foreign Application Priority Data
Jul. 30, 2015 (JP) 2015-151006

(51) Int. Cl. F02D 41/24; F01L 1/344; F02D 13/06; F02D 41/00

(52) U.S. Cl. CPC F02D 41/2464; F01L 1/3442; F01L 2201/00; F02D 41/0087; F02D 13/06

(57) ABSTRACT

A determining unit determines whether the deactivated cylinder is in the activated condition or the deactivated condition. A computing unit computes a synchronize correction amount for synchronizing an activated-side change speed of the activated-side rotational phase and a deactivated-side change speed of the deactivated-side rotational phase with each other, during a deactivated period in which the determining unit determines that the deactivated cylinder is in the deactivated condition. During the deactivated period, a deactivated-side control variable for controlling the deactivated-side rotational phase toward a target phase is corrected with the synchronize correction amount computed by the computing unit.

### CROSS REFERENCE TO RELATED APPLICATION

This application is based on Japanese Patent Application No. 2015-151006 filed on Jul. 30, 2015, the disclosure of which is incorporated herein by reference.

### TECHNICAL FIELD

The present disclosure relates to a valve timing control device.

### BACKGROUND ART

Conventionally, in an internal combustion engine having multiple cylinders, a common valve timing control device controls a phase adjusting mechanism which adjusts a valve timing for each cylinder in order to restrict a deviation in rotational phase between cylinders.

Patent Literature 1 shows a valve timing control device which corrects a controlled variable of a phase adjusting mechanism with respect to at least one of a specified cylinders in which a rotational phase deviation occurs due to components driven by an engine, such as a high-pressure pump, and the other cylinders. A rotational phase deviation can be restricted between the specified cylinders and the other cylinders, and a fuel combustion becomes stable in both of the specified cylinders and the other cylinders. Thus, a variation in output torque can be reduced and drivability can be improved.

In recent years, a variable displacement engine is employed from viewpoints of a fuel saving. The variable displacement engine is provided with activated cylinders which are kept activated and deactivated cylinders which are switched between an activated condition and a deactivated condition. Generally, since a cam torque is not transmitted to intake/exhaust valves of the deactivated cylinder, a rotational phase of the deactivated cylinder may deviated from a rotational phase of an activated cylinder. Even if the device disclosed in Patent Literature 1 is applied to a variable displacement engine, it is hard to avoid a rotational phase deviation of the deactivated cylinder. It is likely that a fuel combustion becomes unstable.

### PRIOR ART LITERATURES

### Patent Literature

### Patent Literature 1: Japanese Patent No. 4453727

### SUMMARY OF INVENTION

It is an object of the present disclosure to provide a valve timing control device which is able to make a fuel combustion stable in a variable displacement engine.

According to a first aspect of the present disclosure, a valve timing control device is applied to a variable displacement engine provided with an activated cylinder which is kept activated and a deactivated cylinder which is switched between an activated condition and a deactivated condition. The valve timing control device has an activated-side phase adjusting mechanism which adjusts an activated-side rotational phase in order to determine a valve timing in the activated cylinder, and an deactivated-side phase adjusting mechanism which adjusts a deactivated-side rotational phase in order to determine a valve timing in the deactivated cylinder. Further, the valve timing control device has a determining unit determining whether the deactivated cylinder is in the activated condition or the deactivated condition; a computing unit computing a synchronize correction amount for synchronizing an activated-side change speed of the activated-side rotational phase and a deactivated-side change speed of the deactivated-side rotational phase with each other, during a deactivated period in which the determining unit determines that the deactivated cylinder is in the deactivated condition; and a correcting unit correcting a deactivated-side control variable with the synchronize correction amount computed by the computing unit during the deactivated period, the deactivated-side control variable being for controlling the deactivated-side rotational phase toward a target phase.

According to the above aspect of the present disclosure, during the deactivated period in which the deactivated cylinder is in the deactivated condition, the synchronize correction amount is computed in order to synchronize the activated-side change speed of the activated-side rotational phase of the activated cylinder and the deactivated-side change speed of the deactivated-side rotational phase of the deactivated cylinder with each other. As the result, during the deactivated period, the deactivated-side control variable is corrected with the synchronize correction amount for controlling the deactivated-side rotational phase toward the target phase. Since the deactivated-side change speed is synchronized with the activated-side change speed, it can be restricted that the deactivated-side rotational phase deviates from the activated-side rotational phase. Therefore, the fuel combustion can be made stable in both of the activated cylinder and the deactivated cylinder.

According to a second aspect of the present disclosure, a valve timing control device is applied to a variable displacement engine provided with an activated cylinder which is kept activated and a deactivated cylinder which is switched between an activated condition and a deactivated condition. The valve timing control device has an activated-side phase adjusting mechanism which adjusts an activated-side rotational phase in order to determine a valve timing in the activated cylinder, and an deactivated-side phase adjusting mechanism which adjusts a deactivated-side rotational phase in order to determine a valve timing in the deactivated cylinder. Further, the valve timing control device has a determining unit determining whether a return condition is established for returning the deactivated cylinder from the deactivated condition to the activated condition; a computing unit computing a synchronize correction amount for synchronizing an activated-side change speed of the activated-side rotational phase and a deactivated-side change speed of the deactivated-side rotational phase with each other when the return condition is established at a return time; and a correcting unit correcting a deactivated-side control variable with the synchronize correction amount computed by the computing unit at the return time, the deactivated-side control variable being for controlling the deactivated-side rotational phase toward a target phase.

According to the second aspect of the present disclosure, when the return condition is established for returning the deactivated cylinder from the deactivated condition to the activated condition, the synchronize correction amount is computed in order to synchronize the activated-side change speed of the activated-side rotational phase of the activated cylinder and the deactivated-side change speed of the deactivated-side rotational phase of the deactivated cylinder with each other. As the result, at the return time, the deactivated-side control variable is corrected with the synchronize correction amount for controlling the deactivated-side rotational phase toward the target phase. Since the deactivated-side change speed is synchronized with the activated-side change speed, it can be restricted that the deactivated-side rotational phase deviates from the activated-side rotational phase. Therefore, the fuel combustion can be made stable in both of the activated cylinder and the deactivated cylinder.

According to a third aspect of the present disclosure, a valve timing control device is applied to a variable displacement engine provided with an activated cylinder which is kept activated and a deactivated cylinder which is switched between an activated condition and a deactivated condition. The valve timing control device has an activated-side phase adjusting mechanism which adjusts an activated-side rotational phase in order to determine a valve timing in the activated cylinder, and an deactivated-side phase adjusting mechanism which adjusts a deactivated-side rotational phase in order to determine a valve timing in the deactivated cylinder. Further, the valve timing control device has a determining unit determining whether a return condition is established for returning the deactivated cylinder from the deactivated condition to the activated condition; a computing unit computing a synchronize correction amount for synchronizing an activated-side change speed of the activated-side rotational phase and a deactivated-side change speed of the deactivated-side rotational phase with each other when the return condition is established at a return time; and a correcting unit correcting target phases of the deactivated-side rotational phase the activated-side rotational phase with the synchronize correction amount computed by the computing unit at the return time.

According to the above third aspect of the present disclosure, when the return condition is established for returning the deactivated cylinder from the deactivated condition to the activated condition, the synchronize correction amount is computed in order to synchronize the activated-side change speed of the activated-side rotational phase of the activated cylinder and the deactivated-side change speed of the deactivated-side rotational phase of the deactivated cylinder with each other. As the result, the target phases of the deactivated-side rotational phase and the activated-side rotational phase are corrected with the synchronize correction amount. Since the deactivated-side change speed is synchronized with the activated-side change speed, it can be restricted that the deactivated-side rotational phase deviates from the activated-side rotational phase. Therefore, the fuel combustion can be made stable in both of the activated cylinder and the deactivated cylinder.

### BRIEF DESCRIPTION OF DRAWINGS

The above and other objects, features and advantages of the present disclosure will become more apparent from the following detailed description made with reference to the accompanying drawings.

FIG. 1 is a front view schematically showing an internal combustion engine to which a valve timing control device is applied according to a first embodiment.

FIG. 2 is a characteristic chart for explaining a cam torque which is applied to an intake camshaft according to the first embodiment.

FIG. 3 is a cross sectional plan view showing a phase adjusting mechanism according to the first embodiment.

FIG. 4 is a graph showing a control correlation data during an activated period according to the first embodiment.

FIG. 5 is a graph showing a control correlation data during a deactivated period according to the first embodiment.

FIG. 6 is a flowchart showing a control flow according to the first embodiment.

FIG. 7 is a flowchart showing a control flow according to a second embodiment.

FIG. 8 is a graph for explaining an individual correlation data according to the second embodiment.

FIG. 9 is a graph for explaining an update of a deactivated-side control variable according to the second embodiment.

FIG. 10 is a flowchart showing a control flow according to a third embodiment.

FIG. 11 is a graph for explaining an individual correlation data according to the third embodiment.

FIG. 12 is a graph for explaining an obtaining method for obtaining an individual correlation data according to the third embodiment.

FIG. 13 is a graph for explaining an update of a deactivated-side control variable according to the third embodiment.

FIG. 14 is a flowchart showing a control flow according to a fourth embodiment.

FIG. 15 is a graph for explaining a synchronize correction amount according to the fourth embodiment.

FIG. 16 is a flowchart showing a control flow according to a fifth embodiment.

FIG. 17 is a graph for explaining a synchronize correction amount according to the fifth embodiment.

FIG. 18 is a flowchart showing a modification of the flowchart shown in FIG. 14.

FIG. 19 is a flowchart showing a modification of the flowchart shown in FIG. 14.

### EMBODIMENTS FOR CARRYING OUT INVENTION

Referring to drawings, a plurality of embodiments of the present disclosure will be described, hereinafter. In each embodiment, the same parts and the components are indicated with the same reference numeral and the same description will not be reiterated. In a case where only a part of configuration is explained in each embodiment, a configuration of preceding embodiment can be applied as the other configuration. Moreover, the configuration of each embodiment can be combined with each other even if it is not explicitly described.

### First Embodiment

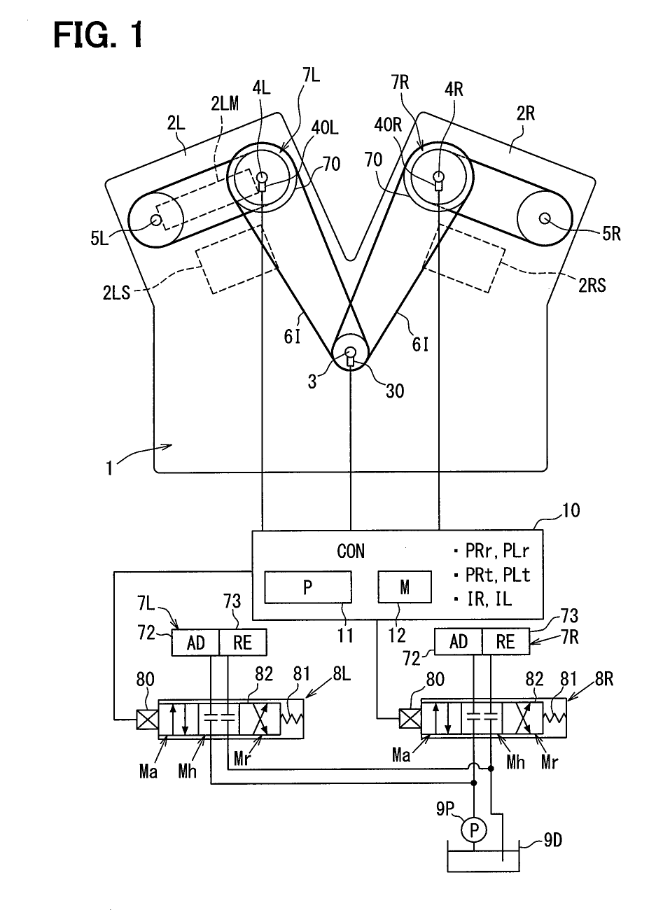

As shown in FIG. 1, a valve timing control device 10 is applied to an internal combustion engine 1 for a vehicle, according to a first embodiment.

The internal combustion engine 1 is a V-type engine having a right bank 2R and a left bank 2L at 60 degrees. A crankshaft 3 is provided to a connecting portion of the right bank 2R and the left bank 2L. A plurality of cylinders 2RS are provided to the right bank 2R, and a single intake camshaft 4R and a single exhaust camshaft 5R are respectively provided to the right bank 2R. Similarly, a plurality of cylinders 2LS are provided to the left bank 2L, and a single intake camshaft 4L and a single exhaust camshaft 5L are respectively provided to the left bank 2L. The internal combustion engine 1 is a gasoline engine in which gasoline is combusted in each cylinder 2RS, 2LS of both banks 2R, 2L.

Crank torque for driving a transaxle of a vehicle is transmitted from the crankshaft 3. The crank torque is transmitted to the intake cam shafts 4R, 4L of both banks 2R, 2L through a housing 70 and a vane rotor 71 of a respective phase adjusting mechanism 7R, 7L (refer to FIG. 3). Each of the intake cam shafts 4R, 4L opens and closes the intake valve at a variable timing, which is provided to each cylinder 2RS, 2LS of the banks 2R, 2L. Also, the crank torque is transmitted to the exhaust cam shafts 5R, 5L of both banks 2R, 2L through the housing 70 of corresponding phase adjusting mechanism 7R, 7L. Each of the exhaust cam shafts 5R, 5L opens and closes the exhaust valve at a fixed timing, which is provided to each cylinder 2RS, 2LS of the corresponding bank 2R, 2L.

While the internal combustion engine 1 is driven, an activated condition is always maintained in each cylinder 2RS of the right bank 2R. In the activated condition, the intake valve and the exhaust valve are opened and closed. Each cylinder 2RS of the right bank 2R which is maintained at the activated condition is referred to as an activated cylinder 2RS, hereinafter. While each of the activated cylinder 2RS of the right bank 2R is in the activated condition, each cylinder 2LS of the left bank 2LS is switched between the activated condition in which the intake valve and the exhaust valve are opened/closed and a deactivated condition in which both valves are not opened/closed, by a cylinder deactivating mechanism 2LM. Each cylinder 2LS of the left bank 2L, which is switched between the activated condition and the deactivated condition, is referred to as a deactivated cylinder 2LS, hereinafter. The cylinder deactivating mechanism 2LM is a rocker arm mechanism or a cam slide mechanism which can interrupt a connection between the camshafts 4L, 5L and both valves in the deactivated condition. As described above, the internal combustion engine 1 functions as a “variable displacement engine.”

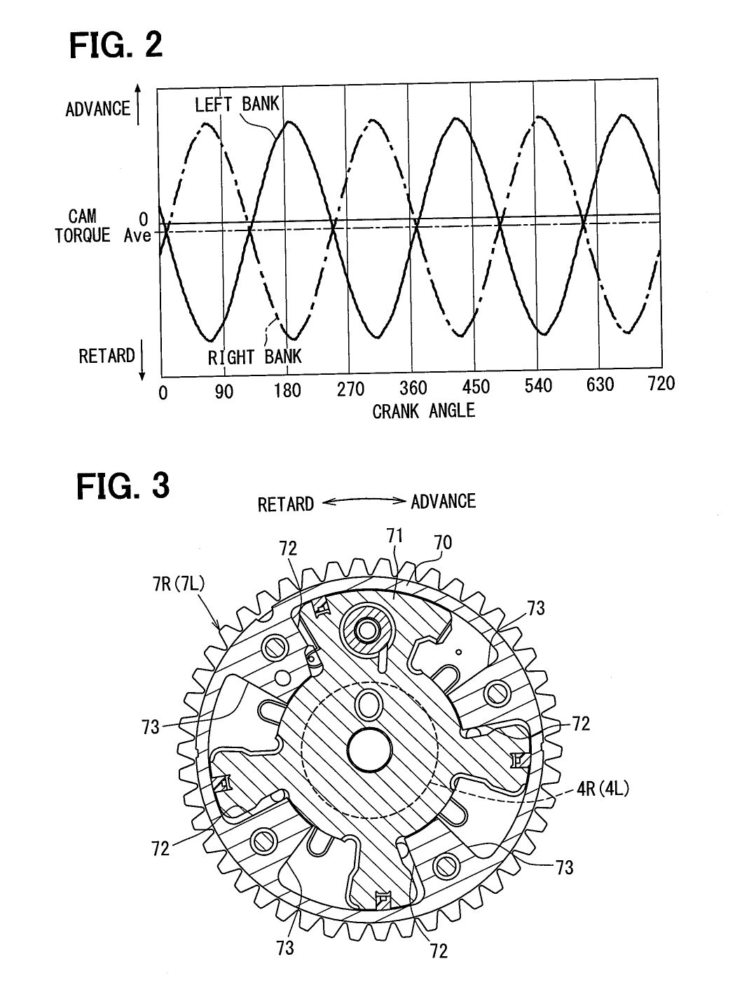

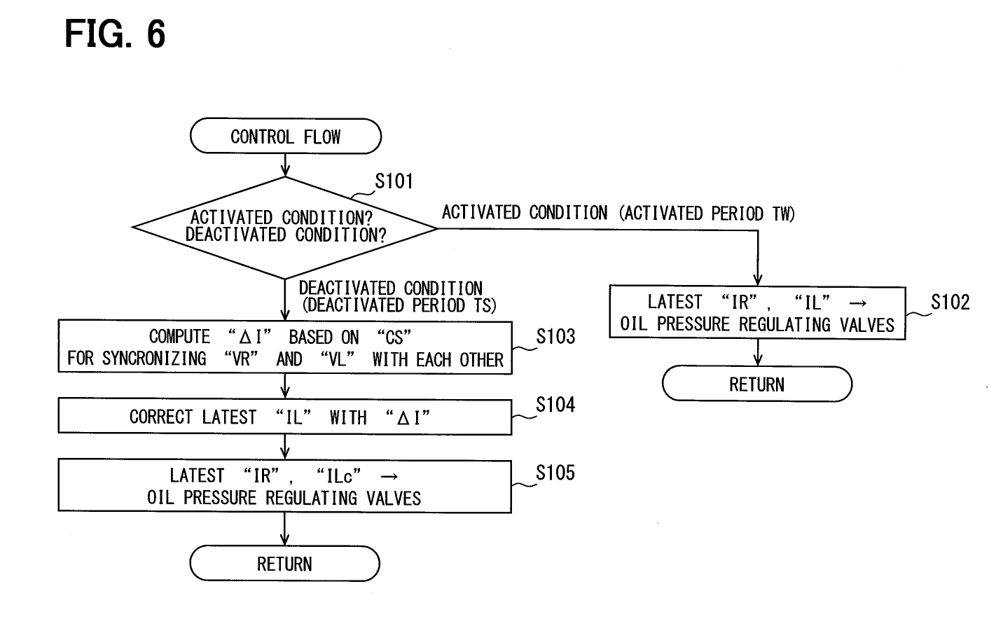

Moreover, during an activated period TW (refer to FIG. 6) in which each deactivated cylinder 2LS is in the activated condition, an alternate cam torque is applied to the intake camshafts 4R, 4L and the exhaust camshafts 5R, 5L of both banks 2R, 2L in an advance direction and a retard direction as shown in FIG. 2 (example of intake camshafts 4R, 4L). An average torque of the cam torque is biased in the retard direction due to friction at each bearing which supports the intake camshafts 4R, 4L and the exhaust camshafts 5R, 5L. Meanwhile, during a deactivated period TS (refer to FIG. 6) in which the each deactivated cylinder 2LS is in the deactivate condition, the cam torque is applied to only cam shafts 4R, 5R of the right bank 2R, which correspond to the activated cylinder 2RS. During the deactivated period TS, since the connection between the camshafts 4L, 5L and the both valves of the left bank 21 corresponding to the deactivated cylinders 2LS is interrupted, the cam shafts 4L, 5L do not receive any cam torque which is generated by a reaction force of a valve spring. When the internal combustion engine is in a transient condition for accelerating the vehicle, the activated period TW is established. When the internal combustion engine is in a stable condition for running the vehicle stably, the deactivated period TS is established.

In both banks 2R, 2L of the internal combustion engine 1 which is running, each of the rotational phases of the intake camshafts 4R, 4L with respect to the crankshaft 3 is independently adjusted by the phase adjusting mechanisms 7R, 7L without respect to a condition of the deactivated cylinders 2LS, as shown in FIGS. 1 and 3. Accordingly, in both banks 2R, 2L, during the activated period TW in which the each deactivated cylinders 2LS is in the activated condition, the valve timing of the intake valve is determined for each of cylinders 2RS, 2LS according to the rotational phase of the intake camshaft which is respectively adjusted by the phase adjusting mechanisms 7R, 7L. The rotational phase of the intake camshafts 4R, 4L relative to the crankshaft 3 will be referred to as a “rotational phase”, generally. Moreover, in the right bank 2R which has a plurality of activated cylinders 2RS, the rotational phase which is adjusted by the activated-side phase adjusting mechanism 7R corresponds to an activated-side rotational phase. In the left bank 2L which has a plurality of deactivated cylinders 2LS, the rotational phase which is adjusted by the deactivated-side phase adjusting mechanism 7L corresponds to a deactivated-side rotational phase.

Each of the phase adjusting mechanisms 7R, 7L is a vane-type hydraulic mechanism which has a vane rotor 71 coaxially accommodated in the housing 70. The housing 70 is rotated along with the crankshaft 3 by a crank torque transmitted from the crankshaft 3 through a transmission member 61, such as a timing chain or a timing belt. Each vane rotor 71 is coaxially connected to the intake camshaft 4R, 4L of corresponding bank 2R, 2L, whereby each vane rotor 71 rotates along with the intake camshaft 4R, 4L. As shown in FIG. 3, the vane rotor 71 divides an interior of the housing 70 in its rotation direction so that a plurality of advance chambers 72 and a plurality of retard chambers 73 are defined therein.

In each of the phase adjusting mechanisms 7R, 7L, when hydraulic fluid is discharged from each of the advance chambers 72 and is introduced into each of the retard chambers 73, the vane rotor 71 rotates in a retard direction relative to the housing 70. As a result, in the bank 2R, 2L corresponding to each phase adjusting mechanism 7R, 7L, the rotational phase is adjusted to be retarded. Thus, when each of cylinders 2RS, 2LS is in the activated condition, the valve timing of the intake valve can be adjusted to be retarded according to the rotational phase.

Meanwhile, in each of the phase adjusting mechanisms 7R, 7L, when the hydraulic fluid is introduced into each of the advance chambers 72 and is discharged from each of the retard chambers 73, the vane rotor 71 rotates in an advance direction relative to the housing 70. As a result, in the bank 2R, 2L corresponding to each phase adjusting mechanism 7R, 7L, the rotational phase is adjusted to be advanced. Thus, when each of cylinders 2RS, 2LS is in the activated condition, the valve timing of the intake valve can be adjusted to be advanced according to the rotational phase.

Furthermore, in each of the phase adjusting mechanisms 7R, 7L, when the hydraulic fluid is held in each advance chamber 72 and each retard chamber 73, the vane rotor 71 rotates along with the housing 70. As a result, in the bank 2R, 2L corresponding to each phase adjusting mechanism 7R, 7L, the rotational phase is held. Thus, when each of cylinders 2RS, 2LS is in the activated condition, the valve timing of the intake valve can be held according to the rotational phase.

A flow of the hydraulic fluid in each phase adjusting mechanism 7R, 7L is independently controlled by each oil pressure regulating valve 8R, 8L as shown in FIG. 1. Each oil pressure regulating valve 8R, 8L is an electromagnetic spool valve which has a return spring 81, a solenoid coil 80 and a spool 82. A position of the spool 82 is defined according to a restoring force of the return spring 81 and an electromagnetic force generated by the solenoid coil 80, which are balanced with each other. Each oil pressure regulating valve 8R, 8L is controlled in three control modes so as to control the position of the spool 82 according to an electric current flowing through the solenoid coil 80.

When each oil pressure regulating valve 8R, 8L is in a retard mode “Mr”, the hydraulic fluid is discharged from the advance chamber 72 of each phase adjusting mechanism 7R, 7L into a drain 9D and the hydraulic fluid is introduced into the retard chamber 73 of the phase adjusting mechanism 7R, 7L from a pump 9P. Meanwhile, when each oil pressure regulating valve 8R, 8L is in an advance mode “Ma”, the hydraulic fluid is introduced into the advance chamber 72 of each phase adjusting mechanism 7R, 7L from the pump 9P and the hydraulic fluid is discharged from the retard chamber 73 of the phase adjusting mechanism 7R, 7L into the drain 9D. Furthermore, when each oil pressure regulating valve 8R, 8L is in a hold mode “Mh”, the advance chamber 72 and the retard chamber 73 of each phase adjusting mechanism 7R, 7L are fluidly interrupted from the pump 9P and the drain 9D.

The valve timing control device 10 is electrically connected to each of the oil pressure regulating valves 8R, 8L. The valve timing control device 10 controls the electric current flowing through the solenoid coil 80 of each oil pressure regulating valve 8R, 8L according to a driving condition of the internal combustion engine 1, whereby the valve timing is adjusted by each phase adjusting mechanism 7R, 7L. The valve timing control device 10 is configured by an engine ECU (Electronic Control Unit) which performs an injection control in which a fuel injection for the internal combustion engine 1 is controlled, an ignition control in which an ignition for the internal combustion engine 1 is controlled, and an energization control for the solenoid coil 80.

The valve timing control device 10 is mainly configured by a microcomputer having a processor 11 and a memory 12. The valve timing control device 10 is connected to various electrical components of a vehicle in a communicative manner. The electrical components include a crank angle sensor 30 and cam angle sensors 40R, 40L which are electromagnetic pick-up angle sensors. The crank angle sensor 30 detects a rotational angle of the crankshaft 3, and outputs a detection signal indicating the rotational angle of the crankshaft 3. Each of the cam angle sensors 40R, 40L detects a rotational angle of each intake camshaft 4R, 4L, and outputs a signal indicating the rotational angle of each intake camshaft 4R, 4L.

The valve timing control device 10 computes the rotational phase for each bank 2R, 2L based on the detection signals transmitted from the crank angle sensor 30 and the cam angle sensors 40R, 40L as actual phase PRr, PLr on which the valve timing is determined for each bank 2R, 2L. Also, the valve timing control device 10 computes a target phase PRt, PLt of the actual phase PRr, PLr based on the detection signals transmitted from the sensors, which are necessary for performing the injection control and ignition control for the internal combustion engine 10. According to the present embodiment, during both of the activated period TW and the deactivated period TS, the target phase PRt and the target phase PLt are computed as the same phase.

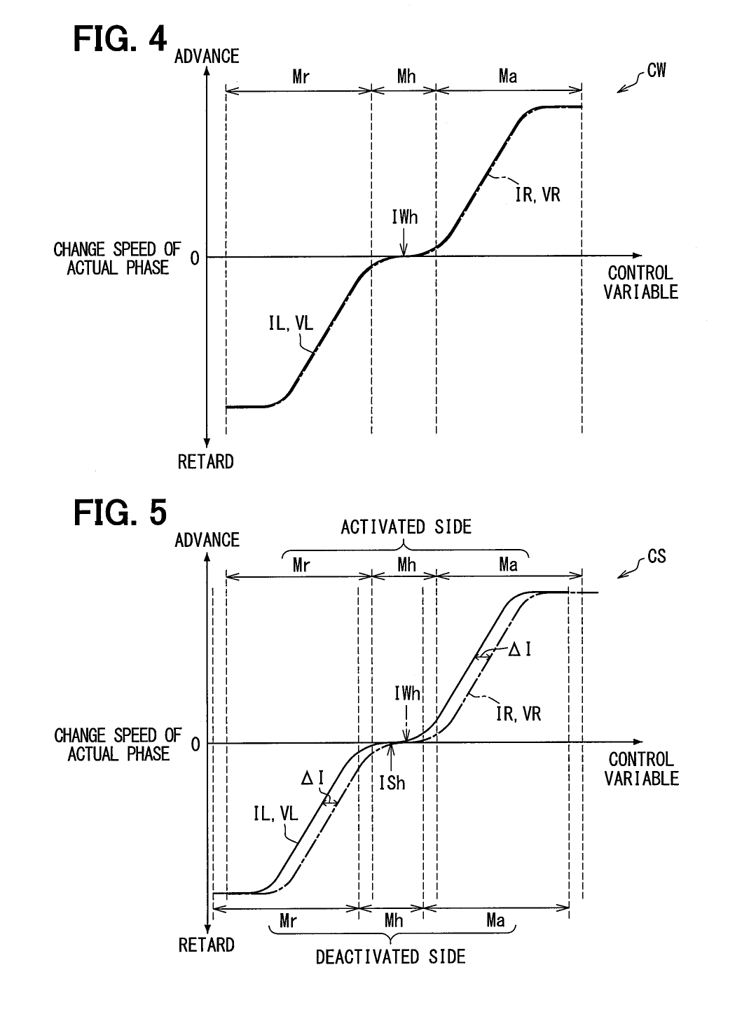

In order to adjust the latest computed actual phase PRr, PLr into the latest computed target phase PRt, PLt, the valve timing control device 10 computes an electric current flowing through the oil pressure regulating valves 8R, 8L in both of the banks 2R, 2L as control variables IR, IL. The electric current which is duty-controlled as the control variables IR, IL is a value indicating the control mode of the oil pressure regulating valves 8R, 8L and a change speed VR, VL of the actual phase PRr, PLr (refer to FIGS. 4 and 5). The change speed VR, VL is represented by a varied angle of the actual phase PRr, PLr per unit time.

During the activated period TW in which each activated cylinder 2RS of the right bank 2R and each deactivated cylinder 2LS of the left bank 2L are in the activated condition, a relationship between the control variables IR, IL, the change speed VR, VL and the control mode is expressed by a control correlation data CW shown in FIG. 4. That is, when the actual phases PRr, PLr are retarded to the target phases PRt, PLt in the retard mode “Mr” during the activated period TW, the change speeds VR, VL are increased as the control variables IR, IL are set smaller in a range less than a specified holding value IWh. Meanwhile, when the actual phases PRr, PLr are advanced to the target phases PRt, PLt in the advance mode “Ma” during the activated period TW, the change speeds VR, VL are increased as the control variables IR, IL are set larger in a range greater than the specified holding value IWh. Furthermore, when the actual phases PRr, PLr are held to the target phases PRt, PLt in the hold mode “Mh” during the activated period TW, the control variables IR, IL are set to the specified holding value IWh or its vicinity, whereby the change speeds VR, VL are held at substantially zero. As described above, during the activated period TW, the change speeds VR, VL are synchronized with each other.

During the deactivated period TS in which each deactivated cylinder 2LS is in the deactivated condition with the each activated cylinder 2RS in the activated condition, a relationship between the control variables IR, IL, the change speed VR, VL and the control mode is expressed by a control correlation data CS shown in FIG. 5. That is, in the deactivated period TS, the correlation between the activated-side control variable IR, the activated-side change speed VR and the control mode, which correspond to the activated cylinders 2RS, is the same as the correlation in the activated period TW. Meanwhile, in the deactivated period TS, the correlation between the deactivated-side control variable IL, the deactivated-side change speed VL and the control mode, which correspond to the deactivated cylinders 2LS, is different from the correlation in the activated period TW.

Specifically, during the retard mode “Mr” in the deactivated period TS, the deactivated-side change speed VL is lower than the activated-side change speed VR at the same control variables IR, IL. The deactivated-side change speed VL is increased as the deactivated-side control variable IL is set smaller in a range where the control variable is less than a holding value ISh. Meanwhile, during the advance mode “Ma” in the deactivated period TS, the deactivated-side change speed VL is higher than the activated-side change speed VR at the same control variables IR, IL. The deactivated-side change speed VL is increased as the deactivated-side control variable IL is set larger in a range where the control variable is greater than the holding value ISh. Furthermore, during the hold mode “Mh” in the deactivated period TS, the deactivated-side control variable IL is set to the holding value ISh or its vicinity so that the deactivated-side change speed VL is held at substantially zero.

The control correlation data CS for the deactivated period TS is defined as a table or a map, which is stored in a memory 12 when the valve timing control device 10 is shipped. During the deactivated period TS, the valve timing control device 10 computes a synchronize correction amount ΔI based on the control correlation data CS stored in the memory 12, as shown in FIG. 5.

The synchronize correction amount ΔI is a value for correcting the deactivated-side control variable IL in such a manner that the activated-side change speed VR of the actual phase PRr and the deactivated-side change speed VL of the actual phase PLr are synchronized with each other during the deactivated period TS. The synchronize correction amount ΔI is expressed by a difference between the control variables IR, IL at the same change speed VR, VL in the control correlation data CS. The synchronize correction amount ΔI is computed as to a feedback gain which derives the deactivated-side control variable IL for feedback controlling the actual phase PLr to the target phase PLt.

Therefore, during the deactivated period TS, the valve timing control device 10 applies the activated-side control variable IR which is based on the actual phase PRr and the target phase PRt to the oil pressure regulating valve 8R according to the control correlation data CS. Also, during the deactivated period TS, the valve timing control device 10 applies the deactivated-side control variable IL which is based on the actual phase PLr and the target phase PLt and is corrected by the synchronize correction amount ΔI to the oil pressure regulating valve 8L according to the control correlation data CS. During the activated period TW, the valve timing control device 10 applies the control variables IR, IL which are computed based on the actual phases PRr, PLR and the target phases PRt, PLt to the oil pressure regulating valves 8R, 8L according to the control correlation data CW.

According to a control flow, the control variables IR, IL are applied to the oil pressure regulating valves 8R, 8L, whereby the phase adjusting mechanisms 7R, 7L are controlled to adjust the actual phases PRr, PLr. Referring to FIG. 6, the above control flow will be described, hereinafter. The processor 11 of the valve timing control device 10 executes control programs stored in the memory 12, whereby the control flow is executed. Thus, the execution of the control flow is started when a power switch is turned on for activating the valve timing control device 10, and is terminated when the power switch is turned off for deactivating the valve timing control device 10. While the control flow is executed, the control variables IR, IL are computed based on the actual phases PRr, PLr and the target phase PRt, PRt. The “latest control variables IR, IL” in the control flow represent newest control variables IR, IL computed in corresponding step.

In S101 of the control flow, it is determined whether each deactivated cylinder 2LS of the left bank 2L is in the activated condition or in the deactivated condition. When it is the activated period TW, the procedure proceeds to S102. When it is the deactivated period TS, the procedure proceeds to S103.

In S102, the latest control variables IR, IL are supplied to the oil pressure regulating valves 8R, 8L. As the result, the actual phases PRr, PLr are adjusted to the target phases PRt, PLT with the change speed VR, VL which are synchronized with each other according to the control correlation data CW. After executing S102, the procedure goes back to S101.

Meanwhile, in S103, the synchronize correction amount ΔI for synchronizing the activated-side change speed VR with the deactivated-side change speed VL is computed based on the control correlation data CS stored in the memory 12. In S104, the latest deactivated-side control variable IL is corrected with the synchronize correction amount ΔI which is computed in S103. In S105, the deactivated-side corrected amount ILc as the deactivated-side control variable IL which is corrected in S103 is supplied to the oil pressure regulating valve 8L, and the latest activated-side control variable IR is supplied to the oil pressure regulating valve 8R. As the result, the actual phases PRr, PLr are adjusted to the target phases PRt, PLT with the change speed VR, VL which are synchronized with each other. After executing S105, the procedure goes back to S101.

According to the first embodiment, the valve timing control device 10 performing S101 corresponds to a “determining unit”. Moreover, the valve timing control device 10 performing S103 corresponds to a “computing unit”. Furthermore, the valve timing control device 10 performing S104, S105 corresponds to a “correcting unit”.

### (Advantages)

Advantages of the first embodiment will be described, hereinafter.

During the deactivated period TS in which the each deactivated cylinder 2LS is in the deactivated condition, the synchronize correction amount ΔI is computed so that the activated-side change speed VR of the actual phase PLr in each activated cylinder 2RS and the deactivated-side change speed VL of the actual phase PLr in each deactivated cylinder 2LS are synchronized with each other. As the result, during the deactivated period TS, the deactivated-side control variable IL is corrected with the synchronize correction amount ΔI for controlling the actual phase PLr toward the target phase PLt in each deactivated cylinder 2LS. Since the deactivated-side change speed VL is synchronized with the activated-side change speed VR, it can be restricted that the actual phase PLr of each deactivated cylinder 2LS deviates from the actual phase PRr of each activated cylinder 2RS. Therefore, the fuel combustion can be made stable in both of the activated cylinders 2RS and the deactivated cylinders 2LS.

Moreover, the synchronize correction amount ΔI can be accurately computed for synchronizing the deactivated-side change speed VL and the activated-side change speed VR, based on the control correlation data CS which represents the relationship between the pre-corrected deactivated-side control variable IL and the pre-corrected deactivated-side change speed VL. Since the deactivated-side change speed VL is accurately synchronized with the activated-side change speed VR, it can be restricted that the actual phase PLr of each deactivated cylinder 2LS deviates from the actual phase PRr of each activated cylinder 2RS. Therefore, the fuel combustion can be made further stable.

### Second Embodiment

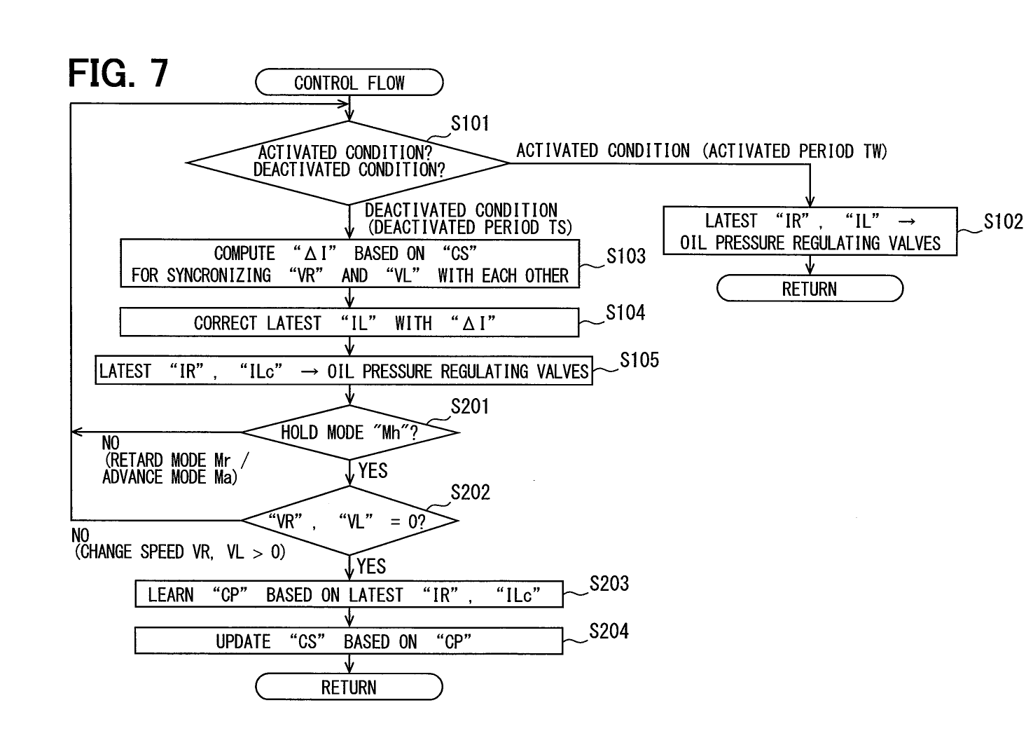

A second embodiment of the present disclosure is a modification of the first embodiment. In a control flow shown in FIG. 7, the procedure proceeds to S201 after executing S105. In S201, it is determined whether the control mode of the oil pressure regulating valves 8R, 8L is the hold mode “Mh”. When the answer is NO (retard mode “Mr”, advance mode “Ma”), the procedure goes back to S101. When the answer is YES (holding mode “Mh”), the procedure proceeds to S202.

In S202, it is determined whether the change speeds VR, VL of the actual phases PRr, PLr become zero. When the answer is NO, the procedure goes back to S101. When the answer is YES, the procedure proceeds to S203.

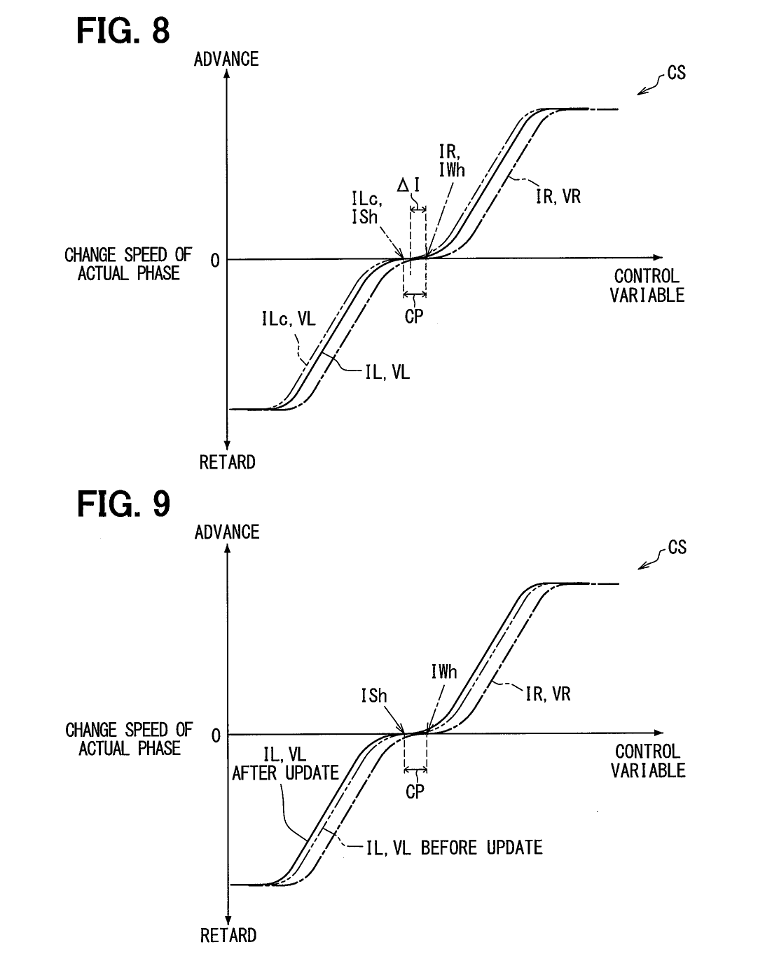

In S203 of the hold mode “Mh”, an individual correlation data CP is learned based on the latest activated-side control variable IR supplied to the oil pressure regulating valve 8R in S105 and the deactivated-side corrected amount ILc supplied to the oil pressure regulating valve 8R in S105. The individual correlation data CP represents a relationship between the control variables IR, ILc, that is, a relationship between the holding values IWh, ISh of when the change speeds VR, VL are zero. In FIG. 8, the individual correlation data CP is represented by a difference between the deactivated-side corrected amount ILc and the activated-side control variable IR, that is, a difference between holding values IWh, ISh.

In S204 of FIG. 7, the control correlation data CS stored in the memory 12 is updated based on the individual correlation data CP which is learned in S203. Specifically, the value of the deactivated-side control variable IL in the control correlation data CS is updated based on the difference or the ratio which the individual correlation data CP represents. In an example shown in FIG. 9, the holding value ISh as the deactivated-side control variable IL corresponding to zero speed in the control correlation data CS is updated to a value which is deviated from the holding value IWh as the activated-side control variable IR corresponding to zero speed by a difference indicated by the individual correlation data CP. Also, in FIG. 9, the deactivated-side control variable IL corresponding to the change speeds VL which is other than zero speed is updated to a value which is deviated from the activated-side control variable IR corresponding to the change speed VR by a value estimated based on a difference represented by the individual correlation data CP.

In the control flow, the procedure goes back to S101 from S204. According to the second embodiment, the valve timing control device 10 performing S201 to S203 corresponds to a “learning unit”. Moreover, the valve timing control device 10 performing S204 corresponds to an “updating unit”.

According to the second embodiment described above, the deactivated-side control variable IL indicated by the control correlation data CS can be updated for each product based on the individual correlation data CP which represents the relationship between the activated-side control variable IR and the deactivated-side corrected amount ILc in the hold mode “Mh”. Thus, by utilizing the control correlation data CS which is updated based on the individual correlation data CP, the synchronize correction amount ΔI can be computed in view of tolerance of each product. Since the synchronization accuracy of the deactivated-side change speed VL with respect to the activated-side change speed VR is enhanced, it can be surely restricted that the actual phase PLr of each deactivated cylinder 2LS deviates from the actual phase PRr of each activated cylinder 2RS. Therefore, the fuel combustion can be made further stable.

### Third Embodiment

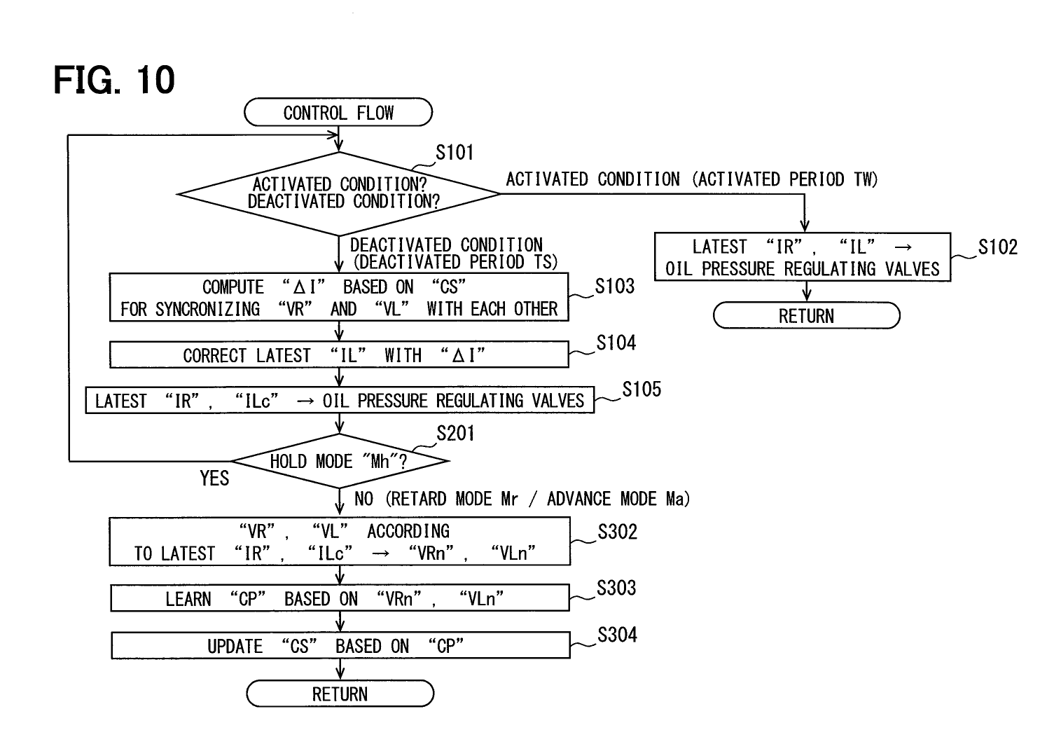

A third embodiment of the present disclosure is a modification of the second embodiment. In the control flow shown in FIG. 10, when the answer is YES in S201 (hold mode “Mh”), the procedure goes back to S101. When the answer is NO in S201 (retard mode “Mr”, advance mode “Ma”), the procedure proceeds to S302. The retard mode “Mr” and the advance mode “Ma” correspond to a “variation mode” in which the actual phases PRr, PLr as the activated-side rotational phase and the deactivated-side rotational phase are changed.

In S302 of the retard mode “Mr” and the advance mode “Ma”, the activated-side change speed VR according to the latest activated-side control variable IR supplied to the oil pressure regulating valve 8R in S105, and the deactivated-side change speed VL according to the deactivated-side corrected amount ILc supplied to the oil pressure regulating valve 8L in S105 are set as attention change speeds VRn, VLn. These attention change speeds VRn, VLn are the change speeds VR, VL which are generated toward the same target phases PRt, PLt.

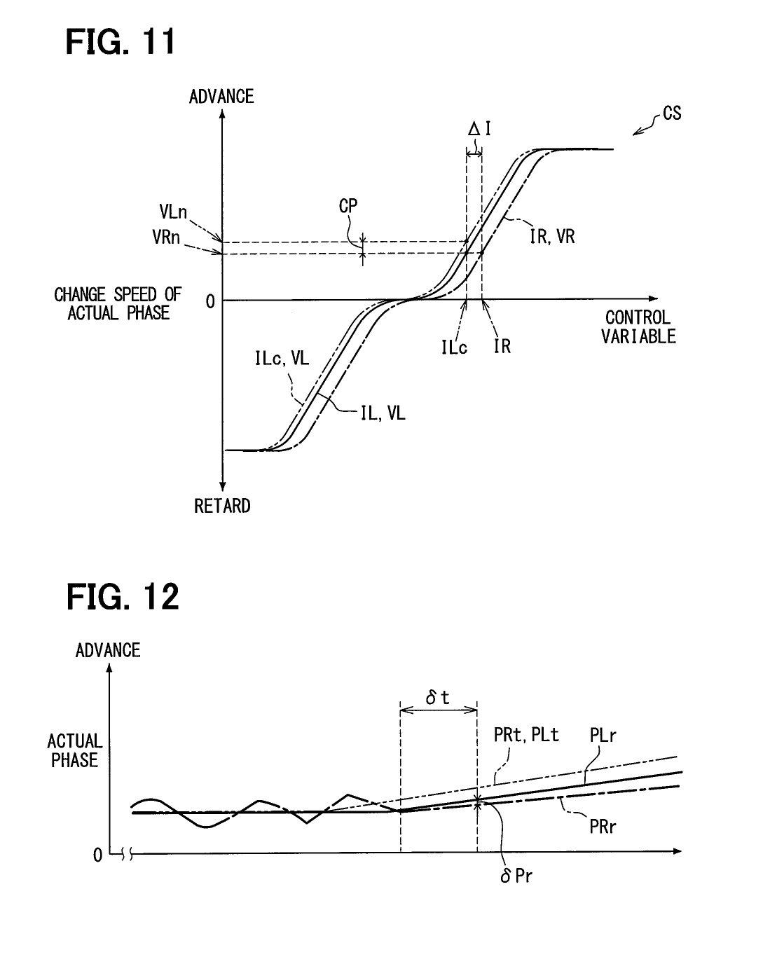

In S303, the individual correlation data CP is learned based on the attention change speeds VRn, VLn which are set in S302. The individual correlation data CP represents a difference or a ratio between the attention change speeds VRn, VLn which exceed the zero speed according to the control variables IR, ILc. In FIG. 11, the individual correlation data CP is represented by a difference between the attention change speed VLn and the attention change speed VRn which correspond to the deactivated-side corrected amount ILc corrected with the synchronize correction amount ΔI. The difference or the ratio between the attention change speeds VRn, VLn is obtained based on a difference or a ratio between the actual phases PRr, PLr which are varied after a specified time δt has elapsed by applying the control variables IR, ILs with the same target phases PRt, PLt, as shown in FIG. 12. The difference between the actual phases PRr, PLr which appear after the specified time δt has elapsed in the advance mode “Ma” is denoted by a reference δPr.

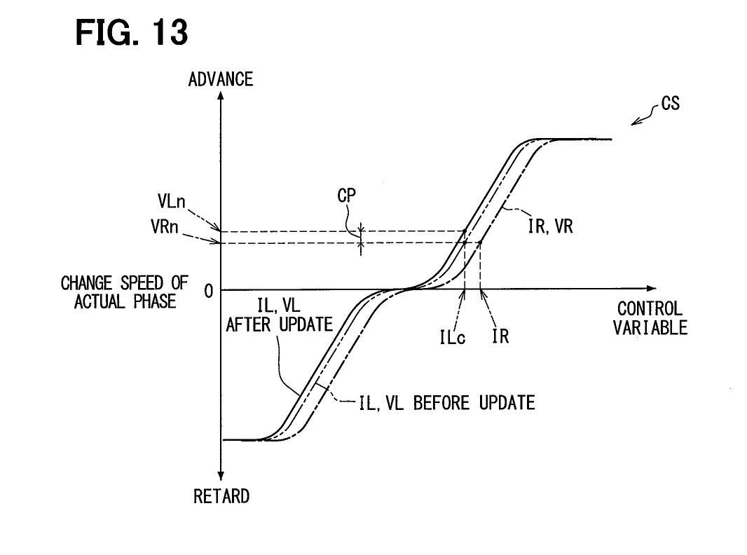

In S304 of FIG. 10, the control correlation data CS stored in the memory 12 is updated based on the individual correlation data CP which is learned in S302. Specifically, the value of the deactivated-side change speed VL in the control correlation data CS is updated based on the difference or the ratio which the individual correlation data CP represents. In an example shown in FIG. 13, the deactivated-side change speed VL according to the deactivated-side corrected amount ILc supplied in S105 is updated to the attention change speed VLn which is deviated from the attention change speed VRn by the difference which is represented by the individual correlation data CP. Also, the deactivated-side change speed VL according to the deactivated-side control variable IL which is other than the deactivated-side corrected amount ILc supplied in S105 is updated to a value which is deviated from the activated-side change speed VR by the difference which is represented by the individual correlation data CP.

In the control flow, the procedure goes back to S101 from S304. According to the third embodiment, the valve timing control device 10 performing S201, S302, S303 corresponds to a “learning unit”. Moreover, the valve timing control device 10 performing S304 corresponds to an “updating unit”.

According to the third embodiment, the individual correlation data CP represents a relationship between the activated-side change speed VR and the deactivated-side change speed VL. The activated-side change speed VR corresponds to the activated-side control variable IR in the retard mode “Mr” and the advance mode “Ma”. The deactivated-side change speed VL corresponds to the deactivated-side corrected amount ILc in the retard mode “Mr” and the advance mode “Ma”. Based on the individual correlation data, the deactivated-side control variable IL represented by the control correlation data CS can be updated for each product. Thus, by utilizing the control correlation data CS which is updated based on the individual correlation data CP, the synchronize correction amount ΔI can be computed in view of tolerance of each product. Since the synchronization accuracy of the deactivated-side change speed VL with respect to the activated-side change speed VR is enhanced, it can be surely restricted that the actual phase PLr of each deactivated cylinder 2LS deviates from the actual phase PRr of each activated cylinder 2RS. Therefore, the fuel combustion can be made further stable.

### Fourth Embodiment

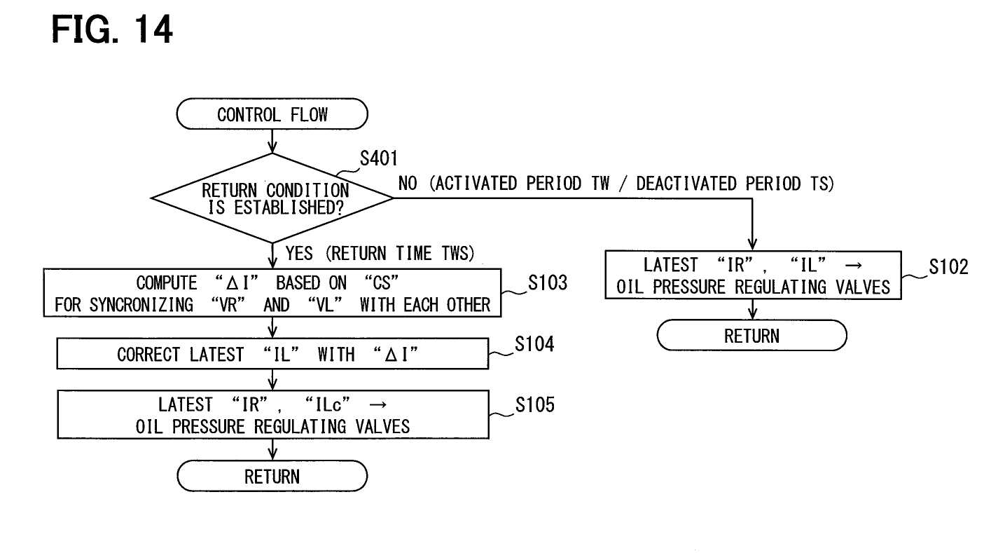

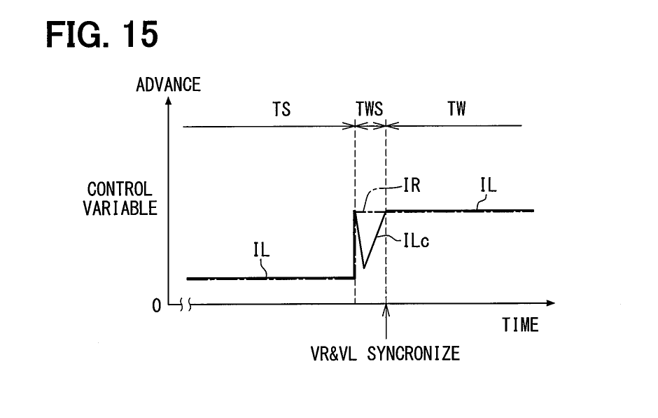

A fourth embodiment of the present disclosure is a modification of the first embodiment. FIG. 14 shows a control flow according to the fourth embodiment. In S401, it is determined whether a return condition is established so that each deactivated cylinder 2LS of the left bank 2L is returned to the activated condition from the deactivated condition. When the internal combustion engine 1 is controlled from a transient condition for accelerating a vehicle to a stable condition for running the vehicle stably, the return condition is established. When it is in the activated period TW or deactivated period TS (answer is NO in S401), the procedure proceeds to S102. When it is a return time TWS (refer to FIG. 15), that is, when it is switched from the deactivated period TS to the activated period TW, the procedure proceeds to S103. According to the fourth embodiment, the valve timing control device 10 performing S401 corresponds to a “determining unit”. It should be noted that the return time TWS may be a time period from the return condition is established until each deactivated cylinder 2LS has returned to the activated condition, as shown in FIG. 15. Alternatively, the return time TWS may be a timing at which the return condition is established, or a timing at which all of the deactivated cylinders 2LS are returned to the activated condition.

According to the fourth embodiment, the synchronize correction amount ΔI is computed in S103. The synchronize correction amount ΔI is a value for computing the deactivated-side corrected amount ILc by correcting the deactivated-side control variable IL so that the change speeds VR, VL are synchronized with each other at the return time TWS shown in FIG. 15. The deactivated-side corrected amount ILc is computed for synchronizing the change speeds VR, VL with each other in the advance mode “Ma” at the return time TWS. The synchronize correction amount ΔI is computed based on the difference between the control variables IR, IL at the same change speed VR, VL in view of the deactivated period TS.

According to the fourth embodiment described above, at the return time TWS at which the return condition is established, the synchronize correction amount ΔI is computed in order that the activated-side change speed VR of the actual phase PLr in each activated cylinder 2RS and the deactivated-side change speed VL of the actual phase PLr in each deactivated cylinder 2LS are synchronized with each other. As the result, at the return time TWS, the deactivated-side control variable IL is corrected with the synchronize correction amount ΔI for controlling the actual phase PLr toward the target phase PLt in each deactivated cylinder 2LS. Since the deactivated-side change speed VL is synchronized with the activated-side change speed VR, it can be restricted that the actual phase PLr of each deactivated cylinder 2LS deviates from the actual phase PRr of each activated cylinder 2RS. Therefore, the fuel combustion can be made stable in both of the activated cylinders 2RS and the deactivated cylinders 2LS.

### Fifth Embodiment

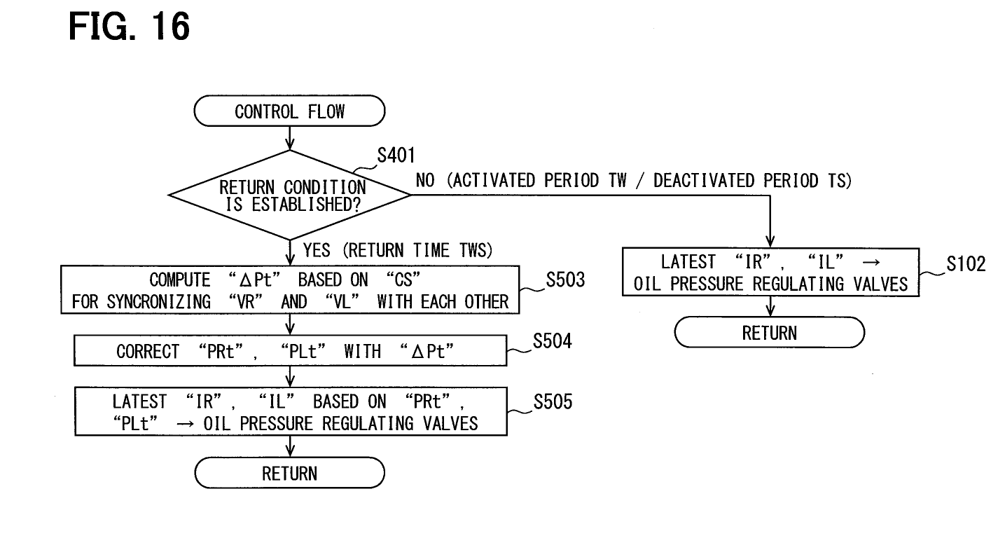

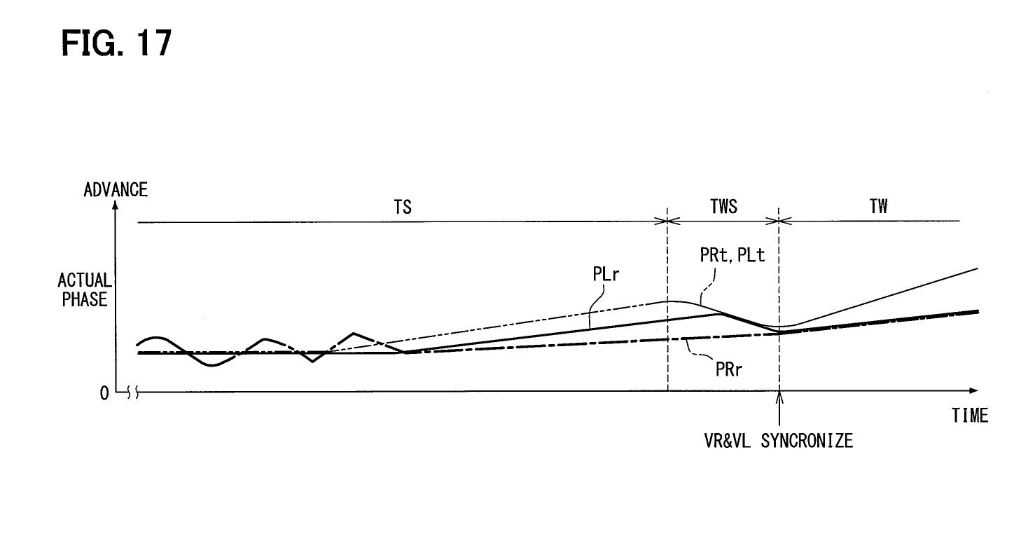

A fifth embodiment of the present disclosure is a modification of the fourth embodiment. In S503 of FIG. 16, the synchronize correction amount ΔPt for synchronizing the activated-side change speed VR with the deactivated-side change speed VL is computed based on the control correlation data CS stored in the memory 12. The synchronize correction amount ΔPt is a value for correcting the target phases PRt, PLt so that the change speeds VR, VL are synchronized with each other at the return time TWS. Specifically, the synchronize correction amount ΔPt is a value for correcting the target phases PRt, PLt according to one of the actual phases PRr, PLr of which change speed VR, VL is slower than the other. FIG. 17 shows that the target phases PRt, PLt are corrected according to the actual phase PRr corresponding to the activated-side change speed VR in the advance mode “Ma” in which the activated-side change speed VR is lower than the deactivated-side change speed VL. The synchronize correction amount ΔPt is computed based on the difference between the control variables IR, IL at the same change speed VR, VL in view of the deactivated period TS. According to the fifth embodiment, the valve timing control device 10 performing S503 corresponds to a “computing unit”.

In the control flow shown in FIG. 16 according to the fifth embodiment, after performing S503, the procedure proceeds to S504, S505 sequentially. In S504, the target phases PRt, PLt for computing the latest control variables IR, IL are corrected with the synchronize correction amount ΔPt computed in S503. In S505, the latest control variables IR, IL which are corrected in S504 are supplied to each oil pressure regulating valves 8R, 8L. According to the fifth embodiment, the valve timing control device 10 performing S504, S505 corresponds to a “correcting unit”.

According to the fifth embodiment described above, at the return time TWS at which the return condition is established, the synchronize correction amount ΔPt is computed in order that the activated-side change speed VR of the actual phase PLr in each activated cylinder 2RS and the deactivated-side change speed VL of the actual phase PLr in each deactivated cylinder 2LS are synchronized with each other. At the return time TWS, the target phases PRt, PLt of the actual phases PRr, PLr are corrected with the synchronize correction amount ΔPt. Since the deactivated-side change speed VL is synchronized with the activated-side change speed VR, it can be restricted that the actual phase PLr of each deactivated cylinder 2LS deviates from the actual phase PRr of each activated cylinder 2RS. Therefore, the fuel combustion can be made stable in both of the activated cylinders 2RS and the deactivated cylinders 2LS.

### Another Embodiment

While the present disclosure has been described with reference to embodiments thereof, it is to be understood that the disclosure is not limited to the embodiments and constructions. The present disclosure is intended to cover various modification and equivalent arrangements within the spirit and scope of the present disclosure.

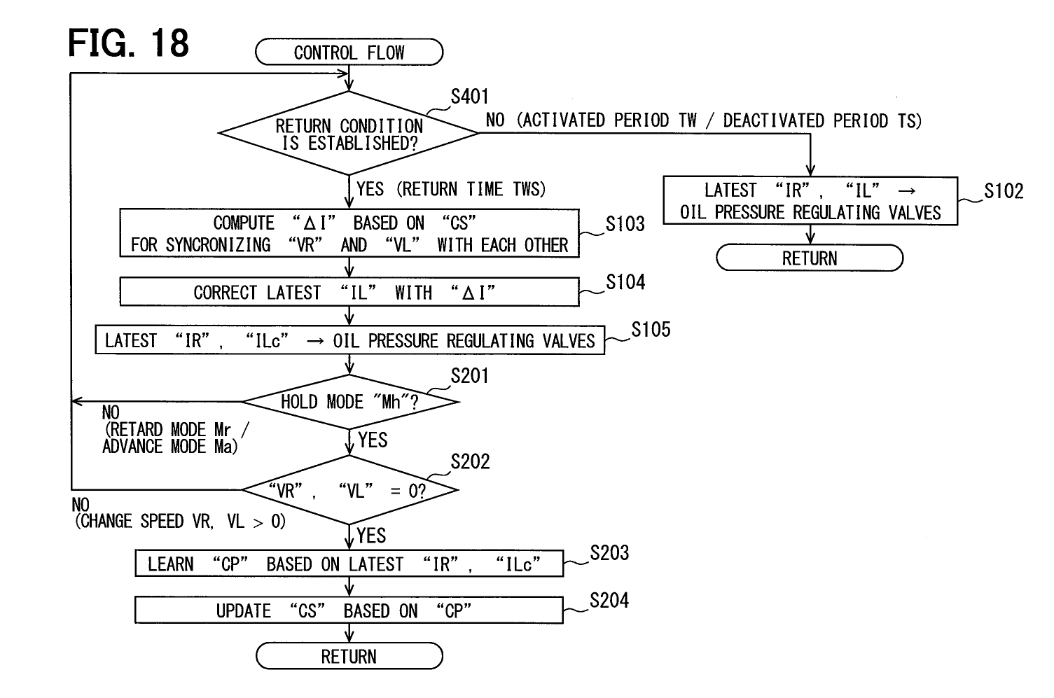

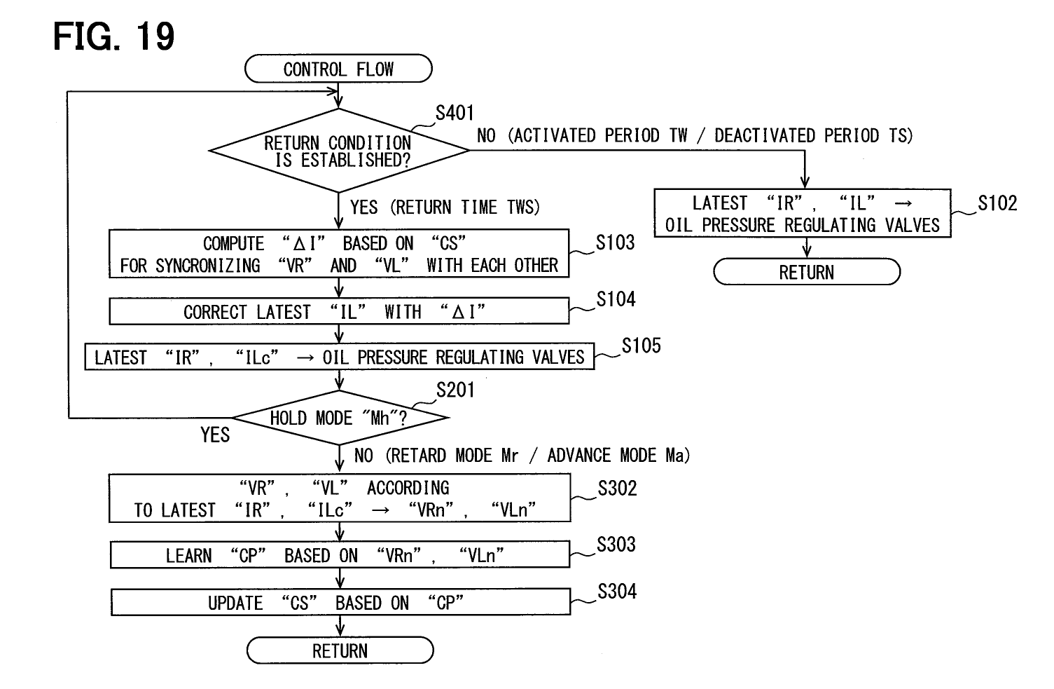

Specifically, according to a first modification of the fourth embodiment, S201 to S204 of the second embodiment shown in FIG. 18 or S201, S302 to S304 of the third embodiment shown in FIG. 19 may be performed after S105 successively. According to a second modification of the fifth embodiment, S201 to S204 of the second embodiment or S201, S302 to S304 of the third embodiment may be performed after S505 successively.

According to a third modification of the second embodiment, in the holding mode “Mh” of the activated period TW, the activated-side control variable IR may be stored in the memory 12 when the activated-side change speed VR becomes zero. In S203 of this modification, the individual correlation data CP is learned based on the activated-side control variable IR stored in the memory 12 and the deactivated-side corrected amount ILc of when the deactivated-side change speed VL becomes zero.

According to a fourth modification of the third embodiment, in the advance mode “Mr” or the retard mode “Ma” of the activated period TW, the activated-side change speed VR according to the activated-side control variable IR may be stored in the memory 12. In S302 of the fourth modification, the activated-side change speed VR stored in the memory 12 is set as the attention change speed VRn, and the deactivated-side change speed VL according to the deactivated-side corrected amount ILc is set as the attention change speed VLn. In S303 of the fourth modification, the individual correlation data CP is learned based on the activated-side change speed VR and the deactivated-side change speed VL.

According to a fifth modification of the first to fifth embodiments, a magnitude correlation between the change speeds VR, VL in the control correlation data CS may be reversed relative to the correlation which is directly or indirectly shown in FIGS. 5, 8, 9, 11 to 13 and 17. According to a sixth modification of the first to fifth embodiments, the synchronize correction amount ΔI, ΔPt may be computed by means of a computing formula programmed in a control program without storing the control correlation data CS in the memory 12.

According to a seventh modification of the first to fifth embodiments, each phase adjusting mechanism 7R, 7L may be a mechanism which adjusts a rotational phase by using of an electric motor or an electromagnetic brake. According to an eighth modification of the first to fifth embodiments, a phase adjusting mechanism may be provided to each cylinder 2RS, 2LS, whereby each cylinder 2RS, 2LS is defined as an activated cylinder or a deactivated cylinder. Moreover, in the eighth modification, the present disclosure may be applied to an inline-cylinder engine 1 having a plurality of cylinders 2RS arranged in a line.

According to a ninth modification of the first to fifth embodiments, the rotational phase of the exhaust camshaft 5R, 5L may be adjusted by the phase adjusting mechanism 7R, 7L. According to a tenth modification of the first to fifth embodiments, the cylinder deactivating mechanism 2LM may be provided to the right bank 2R.

According to an eleventh embodiment of the first to fifth embodiments, the present disclosure may be applied to a flat engine having horizontally-opposed cylinders. According to a twelfth modification of the first to fifth embodiments, the present disclosure may be applied to a diesel engine in which light oil is combusted.

This disclosure is described according to the embodiments. However, it is understood that this disclosure is not limited to the above embodiments or the structures. This disclosure includes various modified examples, and modifications falling within an equivalent range. In addition, while the various combinations and configurations, other combinations and configurations, including more, less or only a single element, are also within the spirit and scope of the present disclosure.

1. A valve timing control device which is applied to a variable displacement engine provided with an activated cylinder which is kept activated and a deactivated cylinder which is switched between an activated condition and a deactivated condition, the valve timing control device controlling an activated-side phase adjusting mechanism which adjusts an activated-side rotational phase in order to determine a valve timing in the activated cylinder, and an deactivated-side phase adjusting mechanism which adjusts a deactivated-side rotational phase in order to determine a valve timing in the deactivated cylinder, the valve timing control device comprising:
a determining unit determining whether the deactivated cylinder is in the activated condition or the deactivated condition;
a computing unit computing a synchronize correction amount for synchronizing an activated-side change speed of the activated-side rotational phase and a deactivated-side change speed of the deactivated-side rotational phase, during a deactivated period in which the determining unit determines that the deactivated cylinder is in the deactivated condition, and
a correcting unit correcting a deactivated-side control variable with the synchronize correction amount computed by the computing unit during the deactivated period, the deactivated-side control variable being for controlling the deactivated-side rotational phase toward a target phase.

2. A valve timing control device which is applied to a variable displacement engine provided with an activated cylinder which is kept activated and a deactivated cylinder which is switched between an activated condition and a deactivated condition, the valve timing control device controlling an activated-side phase adjusting mechanism which adjusts an activated-side rotational phase in order to determine a valve timing in the activated cylinder, and an deactivated-side phase adjusting mechanism which adjusts a deactivated-side rotational phase in order to determine a valve timing in the deactivated cylinder, the valve timing control device comprising:
a determining unit determining whether a return condition is established for returning the deactivated cylinder from the deactivated condition to the activated condition;
a computing unit computing a synchronize correction amount for synchronizing an activated-side change speed of the activated-side rotational phase and a deactivated-side change speed of the deactivated-side rotational phase with each other, at a return time in which the determining unit determines that the return condition is established;
a correcting unit correcting a deactivated-side control variable with the synchronize correction amount computed by the computing unit at the return time, the deactivated-side control variable being for controlling the deactivated-side rotational phase toward a target phase.

3. A valve timing control device which is applied to a variable displacement engine provided with an activated cylinder which is kept activated and a deactivated cylinder which is switched between an activated condition and a deactivated condition, the valve timing control device controlling an activated-side phase adjusting mechanism which adjusts an activated-side rotational phase in order to determine a valve timing in the activated cylinder, and an deactivated-side phase adjusting mechanism which adjusts a deactivated-side rotational phase in order to determine a valve timing in the deactivated cylinder, the valve timing control device comprising:
a determining unit determining whether a return condition is established for returning the deactivated cylinder from the deactivated condition to the activated condition;
a computing unit computing a synchronize correction amount for synchronizing an activated-side change speed of the activated-side rotational phase and a deactivated-side change speed of the deactivated-side rotational phase with each other, at a return time in which the determining unit determines that the return condition is established;
a correcting unit correcting target phases, which are control targets of the deactivated-side rotational phase and the activated-side rotational phase, with the synchronize correction amount computed by the computing unit, at the return time.

4. The valve timing control device according to claim 1, wherein
the computing unit computes the synchronize correction amount based on a control correlation data which represents a relationship between a pre-corrected deactivated-side control variable and the deactivated-side change speed.

5. The valve timing control device according to claim 3,
the computing unit computes the synchronize correction amount based on a control correlation data which represents a relationship between a pre-corrected control variable as a deactivated-side control variable for controlling the deactivated-side rotational phase to the target phase and the deactivated-side change speed.

6. The valve timing control device according to claim 4, further comprising:
a learning unit learning an individual correlation data representing a relationship between an activated-side control variable for controlling the activated-side rotational phase toward the target phase in a holding mode in which the activated-side rotational phase and the deactivated-side rotational phase are held, and the deactivated-side control variable which is corrected in the holding mode, and
an updating unit updating the control correlation data based on the individual correlation data which the learning unit learns.

7. The valve timing control device according to claim 4, further comprising:
a learning unit learning an individual correlation data representing a relationship between the activated-side change speed corresponding to the activated-side control variable for controlling the activated-side rotational phase toward the target phase in a variation mode in which the activated-side rotational phase and the deactivated-side rotational phase are changed, and the deactivated-side change speed corresponding to the deactivated-side control variable which is corrected in the variation mode, and
an updating unit updating the control correlation data based on the individual correlation data which the learning unit learns.
